(19) United States
(12) Patent Application Publication
(10) Pub. No.: US 2024/0334343 A1
(43) Pub. Date: Oct. 3, 2024

(54) METHODS, APPARATUSES, AND COMPUTER READABLE MEDIA FOR POWER CONTROL ON NEGATIVE ACKNOWLEDGEMENT TRANSMISSION

(71) Applicant: Nokia Technologies OY, Espoo (FI)

(72) Inventors: Volker PAULI, Munich (DE); David BHATOOLAUL, Swindon, Wiltshire (GB); Naizheng ZHENG, Beijing (CN); Ugur Baran ELMALI, Munich (DE); Athul PRASAD, Naperville, IL (US); David NAVRÁTIL, Espoo (FI)

(21) Appl. No.: 18/574,253

(22) PCT Filed: Jul. 28, 2021
(86) PCT No.: PCT/CN2021/108828

§ 371 Date: Dec. 26, 2023

(51) Int. Cl. H04W 52/20; H04L 1/1822

(52) U.S. Cl. CPC H04W 52/20; H04L 1/1822

(57) ABSTRACT

Disclosed are methods for power control on negative acknowledgement transmission. An example method may include receiving at a terminal device from a network device, at least one parameter relating to a transmit power for transmission of a negative acknowledgement from the terminal device to the network device on a hybrid automatic repeat request process, wherein the negative acknowledgement may indicate a request for a retransmission of a packet sent from the network device to the terminal device on the hybrid automatic repeat request process, determining at least one missed negative acknowledgement, wherein the at least one missed negative acknowledgement may include at least one sent negative acknowledgement for which no corresponding retransmission from the network device has been received at the terminal device on the hybrid automatic repeat request process, calculating a negative acknowledgement miss rate based at least on the determination of the at least one missed negative acknowledgement, and adjusting the transmit power for the transmission of the negative acknowledgement based at least on the calculated negative acknowledgement miss rate and the at least one parameter. Related apparatuses and computer readable media are also disclosed.

### TECHNICAL FIELD

Various embodiments relate to methods, apparatuses, and computer readable media for power control on negative acknowledgement (NACK) transmission.

### BACKGROUND

Hybrid automatic repeat request (HARQ) may be used for multicast service and broadcast service. When a user equipment (UE) device succeeds in decoding a physical downlink shared channel (PDSCH) transmission of a point to multipoint (PTM) service, the UE device may transmit an acknowledgement (ACK) feedback message. When a UE device cannot decode a PDSCH transmission of a PTM service, the UE device may transmit a NACK feedback message to request a retransmission. In the context of PTM two HARQ feedback modes are relevant: In one mode ACK/NACK HARQ feedback is transmitted on a UE-specific physical uplink control channel (PUCCH) resource, while in the other NACK-only HARQ feedback is transmitted on a group-common PUCCH resource. A high transmit power, aggregated across various UE devices sending NACK simultaneously, of the NACK may contribute a high reliability of transmission of the NACK-only HARQ feedback. However, more UE devices simultaneously transmitting NACK on the same resource may cause more aggregated power, and thus there will be more interference in a cell and to neighboring cells.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a method. The method may include receiving at a terminal device from a network device, at least one parameter relating to a transmit power for transmission of a negative acknowledgement from the terminal device to the network device on a hybrid automatic repeat request process, wherein the negative acknowledgement may indicate a request for a retransmission of a packet sent from the network device to the terminal device on the hybrid automatic repeat request process, determining at least one missed negative acknowledgement, wherein the at least one missed negative acknowledgement may include at least one sent negative acknowledgement for which no corresponding retransmission from the network device has been received at the terminal device on the hybrid automatic repeat request process, calculating a negative acknowledgement miss rate based at least on the determination of the at least one missed negative acknowledgement, and adjusting the transmit power for the transmission of the negative acknowledgement based at least on the calculated negative acknowledgement miss rate and the at least one parameter.

In some embodiments, the at least one parameter, the at least one missed negative acknowledgement, the negative acknowledgement miss rate and the transmit power for the transmission of the negative acknowledgement are determined per at least one hybrid automatic repeat request transmission index of the hybrid automatic repeat request process.

In some embodiments, the at least one missed negative acknowledgement may include at least one sent negative acknowledgement for which a transmission with a hybrid automatic repeat request transmission index is received on the hybrid automatic repeat request process, and the hybrid automatic repeat request transmission index is different from a hybrid automatic repeat request transmission index requested by the terminal device for the requested retransmission.

In some embodiments, the at least one missed negative acknowledgement may include at least one sent negative acknowledgement for which a requested retransmission with a hybrid automatic repeat request transmission index requested by the terminal device is not detected during a first period of time on the hybrid automatic repeat request process.

In some embodiments, the at least one parameter may include at least one of a tolerated negative acknowledgement miss rate, a first step size, a second step size, a first transmit power limit, and a second transmit power limit.

In some embodiments, the negative acknowledgement miss rate may be calculated based at least on at least one of a number of the at least one missed negative acknowledgement and a number of at least one sent negative acknowledgement.

In some embodiments, the method may further include determining the first step size and/or the second step size based at least partly on at least one of the calculated negative acknowledgement miss rate and the tolerated negative acknowledgement miss rate.

In some embodiments, the adjustment of the transmit power for the transmission of the negative acknowledgement may include incrementing the transmit power by the first step size when the calculated negative acknowledgement miss rate is above the tolerated negative acknowledgement miss rate.

In some embodiments, the adjustment of the transmit power for the transmission of the negative acknowledgement may include incrementing a transmit power associated with at least one subsequent hybrid automatic repeat request transmission index by the first step size when the calculated negative acknowledgement miss rate for a hybrid automatic repeat request transmission index is above the tolerated negative acknowledgement miss rate.

In some embodiments, the adjustment of the transmit power for the transmission of the negative acknowledgement may include maintaining the incremented transmit power for a second period of time.

In some embodiments, the adjustment of the transmit power for the transmission of the negative acknowledgement may include decrementing the transmit power by the second step size when the calculated negative acknowledgement miss rate is below the tolerated negative acknowledgement miss rate.

In some embodiments, the adjustment of the transmit power for the transmission of the negative acknowledgement may include decrementing a transmit power associated with at least one subsequent hybrid automatic repeat request transmission index by the second step size when the calculated negative acknowledgement miss rate for a hybrid automatic repeat request transmission index is below the tolerated negative acknowledgement miss rate.

In some embodiments, the method may further include refraining from transmitting the negative acknowledgement when the transmit power for the transmission of the negative acknowledgement is below the second transmit power limit.

In some embodiments, the at least one missed negative acknowledgement may include the negative acknowledgement refrained from being transmitted for which no retransmission has been received on the hybrid automatic repeat request process.

In some embodiments, the adjustment of the transmit power for the transmission of the negative acknowledgement may include refraining from decrementing the transmit power when a retransmission with a requested hybrid automatic repeat request transmission index is received on the hybrid automatic repeat request process.

In some embodiments, the method may further include transmitting a request for increasing the first transmit power limit based at least on the transmit power and the first transmit power limit, wherein a difference between the transmit power and the first transmit power limit may be below a threshold.

In a second aspect, disclosed is a method. The method may include configuring at least one parameter relating to a transmit power for transmission of a negative acknowledgement from at least one terminal device on a hybrid automatic repeat request process, wherein the negative acknowledgement may indicate a request for a retransmission of a packet sent to the at least one terminal device, and transmitting the configuration to the at least one terminal device.

In some embodiments, the at least one parameter may be associated with at least one hybrid automatic repeat request transmission index of the hybrid automatic repeat request process, and the at least one parameter may include at least one of a tolerated negative acknowledgement miss rate, a first step size, a second step size, a first transmit power limit, and a second transmit power limit.

In some embodiments, the configuring the at least one parameter relating to the transmit power for the transmission of the negative acknowledgement may include reducing the first transmit power limit when a request for increasing the first transmit power limit from the at least one terminal device is absent.

In some embodiments, the configuring the at least one parameter relating to the transmit power for the transmission of the negative acknowledgement may include increasing the first transmit power limit when receiving from at least one of the at least one terminal device a request for increasing the first transmit power limit.

In a third aspect, disclosed is an apparatus. The apparatus may include at least one processor and at least one memory. The at least one memory may include computer program code, and the at least one memory and the computer program code may be configured to, with the at least one processor, cause the apparatus as a terminal device to perform receiving from a network device, at least one parameter relating to a transmit power for transmission of a negative acknowledgement from the terminal device to the network device on a hybrid automatic repeat request process, wherein the negative acknowledgement may indicate a request for a retransmission of a packet sent from the network device to the terminal device on a hybrid automatic repeat request process, determining at least one missed negative acknowledgement, wherein the at least one missed negative acknowledgement may include at least one sent negative acknowledgement for which no corresponding retransmission from the network device has been received at the terminal device on the hybrid automatic repeat request process, calculating a negative acknowledgement miss rate based at least on the determination of the at least one missed negative acknowledgement, and adjusting the transmit power for the transmission of the negative acknowledgement based at least on the calculated negative acknowledgement miss rate and the at least one parameter.

In some embodiments, the at least one parameter, the at least one missed negative acknowledgement, the negative acknowledgement miss rate and the transmit power for the transmission of the negative acknowledgement are determined per at least one hybrid automatic repeat request transmission index of the hybrid automatic repeat request process.

In some embodiments, the at least one missed negative acknowledgement may include at least one sent negative acknowledgement for which a transmission with a hybrid automatic repeat request transmission index is received on the hybrid automatic repeat request process, and the hybrid automatic repeat request transmission index is different from a hybrid automatic repeat request transmission index requested by the terminal device for the requested retransmission.

In some embodiments, the at least one missed negative acknowledgement may include at least one sent negative acknowledgement for which a requested retransmission with a hybrid automatic repeat request transmission index requested by the terminal device is not detected during a first period of time on the hybrid automatic repeat request process.

In some embodiments, the at least one parameter may include at least one of a tolerated negative acknowledgement miss rate, a first step size, a second step size, a first transmit power limit, and a second transmit power limit.

In some embodiments, the negative acknowledgement miss rate may be calculated based at least on at least one of a number of the at least one missed negative acknowledgement and a number of at least one sent negative acknowledgement.

In some embodiments, the at least one memory and the computer program code may be further configured to, with the at least one processor, cause the apparatus to further perform determining the first step size and/or the second step size based at least partly on at least one of the calculated negative acknowledgement miss rate and the tolerated negative acknowledgement miss rate.

In some embodiments, the adjustment of the transmit power for the transmission of the negative acknowledgement may include incrementing the transmit power by the first step size when the calculated negative acknowledgement miss rate is above the tolerated negative acknowledgement miss rate.

In some embodiments, the adjustment of the transmit power for the transmission of the negative acknowledgement may include incrementing a transmit power associated with at least one subsequent hybrid automatic repeat request transmission index by the first step size when the calculated negative acknowledgement miss rate for a hybrid automatic repeat request transmission index is above the tolerated negative acknowledgement miss rate.

In some embodiments, the adjustment of the transmit power for the transmission of the negative acknowledgement may include maintaining the incremented transmit power for a second period of time.

In some embodiments, the adjustment of the transmit power for the transmission of the negative acknowledgement may include decrementing the transmit power by the second step size when the calculated negative acknowledgement miss rate is below the tolerated negative acknowledgement miss rate.

In some embodiments, the adjustment of the transmit power for the transmission of the negative acknowledgement may include decrementing a transmit power associated with at least one subsequent hybrid automatic repeat request transmission index by the second step size when the calculated negative acknowledgement miss rate for a hybrid automatic repeat request transmission index is below the tolerated negative acknowledgement miss rate.

In some embodiments, the at least one memory and the computer program code may be further configured to, with the at least one processor, cause the apparatus to further perform refraining from transmitting the negative acknowledgement when the transmit power for the transmission of the negative acknowledgement is below the second transmit power limit.

In some embodiments, the at least one missed negative acknowledgement may include the negative acknowledgement refrained from being transmitted for which no retransmission has been received on the hybrid automatic repeat request process.

In some embodiments, the adjustment of the transmit power for the transmission of the negative acknowledgement may include refraining from decrementing the transmit power when a retransmission with a requested hybrid automatic repeat request transmission index is received on the hybrid automatic repeat request process.

In some embodiments, the at least one memory and the computer program code may be further configured to, with the at least one processor, cause the apparatus to further perform transmitting a request for increasing the first transmit power limit based at least on the transmit power and the first transmit power limit, wherein a difference between the transmit power and the first transmit power limit may be below a threshold.

In a fourth aspect, disclosed is an apparatus. The apparatus may include at least one processor and at least one memory. The at least one memory may include computer program code, and the at least one memory and the computer program code may be configured to, with the at least one processor, cause the apparatus as a network device to perform configuring at least one parameter relating to a transmit power for transmission of a negative acknowledgement from at least one terminal device to the network device on a hybrid automatic repeat request process, wherein the negative acknowledgement may indicate a request for a retransmission of a packet from the network device sent to the at least one terminal device, and transmitting the configuration to the at least one terminal device.

In some embodiments, the at least one parameter may be associated with at least one hybrid automatic repeat request transmission index of the hybrid automatic repeat request process, and the at least one parameter may include at least one of a tolerated negative acknowledgement miss rate, a first step size, a second step size, a first transmit power limit, and a second transmit power limit.

In some embodiments, the configuring the at least one parameter relating to the transmit power for the transmission of the negative acknowledgement may include reducing the first transmit power limit when a request for increasing the first transmit power limit from the at least one terminal device is absent.

In some embodiments, the configuring the at least one parameter relating to the transmit power for the transmission of the negative acknowledgement may include increasing the first transmit power limit when receiving from at least one of the at least one terminal device a request for increasing the first transmit power limit.

In a fifth aspect, disclosed is an apparatus. The apparatus as a terminal device may include means for receiving from a network device, at least one parameter relating to a transmit power for transmission of a negative acknowledgement from the terminal device to the network device on a hybrid automatic repeat request process, wherein the negative acknowledgement may indicate a request for a retransmission of a packet sent from the network device to the terminal device on a hybrid automatic repeat request process, means for determining at least one missed negative acknowledgement, wherein the at least one missed negative acknowledgement may include at least one sent negative acknowledgement for which no corresponding retransmission from the network device has been received at the terminal device on the hybrid automatic repeat request process, means for calculating a negative acknowledgement miss rate based at least on the determination of the at least one missed negative acknowledgement, and means for adjusting the transmit power for the transmission of the negative acknowledgement based at least on the calculated negative acknowledgement miss rate and the at least one parameter.

In some embodiments, the at least one parameter, the at least one missed negative acknowledgement, the negative acknowledgement miss rate and the transmit power for the transmission of the negative acknowledgement are determined per at least one hybrid automatic repeat request transmission index of the hybrid automatic repeat request process.

In some embodiments, the at least one missed negative acknowledgement may include at least one sent negative acknowledgement for which a transmission with a hybrid automatic repeat request transmission index is received on the hybrid automatic repeat request process, and the hybrid automatic repeat request transmission index is different from a hybrid automatic repeat request transmission index requested by the terminal device for the requested retransmission.

In some embodiments, the at least one missed negative acknowledgement may include at least one sent negative acknowledgement for which a requested retransmission with a hybrid automatic repeat request transmission index requested by the terminal device is not detected during a first period of time on the hybrid automatic repeat request process.

In some embodiments, the at least one parameter may include at least one of a tolerated negative acknowledgement miss rate, a first step size, a second step size, a first transmit power limit, and a second transmit power limit.

In some embodiments, the negative acknowledgement miss rate may be calculated based at least on at least one of a number of the at least one missed negative acknowledgement and a number of at least one sent negative acknowledgement.

In some embodiments, the apparatus may further include means for determining the first step size and/or the second step size based at least partly on at least one of the calculated negative acknowledgement miss rate and the tolerated negative acknowledgement miss rate.

In some embodiments, the adjustment of the transmit power for the transmission of the negative acknowledgement may include incrementing the transmit power by the first step size when the calculated negative acknowledgement miss rate is above the tolerated negative acknowledgement miss rate.

In some embodiments, the adjustment of the transmit power for the transmission of the negative acknowledgement may include incrementing a transmit power associated with at least one subsequent hybrid automatic repeat request transmission index by the first step size when the calculated negative acknowledgement miss rate for a hybrid automatic repeat request transmission index is above the tolerated negative acknowledgement miss rate.

In some embodiments, the adjustment of the transmit power for the transmission of the negative acknowledgement may include maintaining the incremented transmit power for a second period of time.

In some embodiments, the adjustment of the transmit power for the transmission of the negative acknowledgement may include decrementing the transmit power by the second step size when the calculated negative acknowledgement miss rate is below the tolerated negative acknowledgement miss rate.

In some embodiments, the adjustment of the transmit power for the transmission of the negative acknowledgement may include decrementing a transmit power associated with at least one subsequent hybrid automatic repeat request transmission index by the second step size when the calculated negative acknowledgement miss rate for a hybrid automatic repeat request transmission index is below the tolerated negative acknowledgement miss rate.

In some embodiments, the apparatus may further include means for refraining from transmitting the negative acknowledgement when the transmit power for the transmission of the negative acknowledgement is below the second transmit power limit.

In some embodiments, the at least one missed negative acknowledgement may include the negative acknowledgement refrained from being transmitted for which no retransmission has been received on the hybrid automatic repeat request process.

In some embodiments, the adjustment of the transmit power for the transmission of the negative acknowledgement may include refraining from decrementing the transmit power when a retransmission with a requested hybrid automatic repeat request transmission index is received on the hybrid automatic repeat request process.

In some embodiments, the apparatus may further include means for transmitting a request for increasing the first transmit power limit based at least on the transmit power and the first transmit power limit, wherein a difference between the transmit power and the first transmit power limit may be below a threshold.

In a sixth aspect, disclosed is an apparatus. The apparatus as a network device may include means for configuring at least one parameter relating to a transmit power for transmission of a negative acknowledgement from at least one terminal device to the network device on a hybrid automatic repeat request process, wherein the negative acknowledgement may indicate a request for a retransmission of a packet sent from the network device to the at least one terminal device, and means for transmitting the configuration to the at least one terminal device.

In some embodiments, the at least one parameter may be associated with at least one hybrid automatic repeat request transmission index of the hybrid automatic repeat request process, and the at least one parameter may include at least one of a tolerated negative acknowledgement miss rate, a first step size, a second step size, a first transmit power limit, and a second transmit power limit.

In some embodiments, the means for configuring the at least one parameter relating to the transmit power for the transmission of the negative acknowledgement may include means for reducing the first transmit power limit when a request for increasing the first transmit power limit from the at least one terminal device is absent.

In some embodiments, the means for configuring the at least one parameter relating to the transmit power for the transmission of the negative acknowledgement may include means for increasing the first transmit power limit when receiving from at least one of the at least one terminal device a request for increasing the first transmit power limit.

In a seventh aspect, a computer readable medium is disclosed. The computer readable medium may include instructions stored thereon for causing an apparatus as a terminal device to perform receiving from a network device, at least one parameter relating to a transmit power for transmission of a negative acknowledgement from the terminal device to the network device on a hybrid automatic repeat request process, wherein the negative acknowledgement may indicate a request for a retransmission of a packet sent from the network device to the terminal device on a hybrid automatic repeat request process, determining at least one missed negative acknowledgement, wherein the at least one missed negative acknowledgement may include at least one sent negative acknowledgement for which no corresponding retransmission from the network device has been received at the terminal device on the hybrid automatic repeat request process, calculating a negative acknowledgement miss rate based at least on the determination of the at least one missed negative acknowledgement, and adjusting the transmit power for the transmission of the negative acknowledgement based at least on the calculated negative acknowledgement miss rate and the at least one parameter.

In some embodiments, the at least one parameter, the at least one missed negative acknowledgement, the negative acknowledgement miss rate and the transmit power for the transmission of the negative acknowledgement are determined per at least one hybrid automatic repeat request transmission index of the hybrid automatic repeat request process.

In some embodiments, the at least one missed negative acknowledgement may include at least one sent negative acknowledgement for which a transmission with a hybrid automatic repeat request transmission index is received on the hybrid automatic repeat request process, and the hybrid automatic repeat request transmission index is different from a hybrid automatic repeat request transmission index requested by the terminal device for the requested retransmission.

In some embodiments, the at least one missed negative acknowledgement may include at least one sent negative acknowledgement for which a requested retransmission with a hybrid automatic repeat request transmission index requested by the terminal device is not detected during a first period of time on the hybrid automatic repeat request process.

In some embodiments, the at least one parameter may include at least one of a tolerated negative acknowledgement miss rate, a first step size, a second step size, a first transmit power limit, and a second transmit power limit.

In some embodiments, the negative acknowledgement miss rate may be calculated based at least on at least one of a number of the at least one missed negative acknowledgement and a number of at least one sent negative acknowledgement.

In some embodiments, the computer readable medium may further include instructions stored thereon for causing an apparatus to further perform determining the first step size and/or the second step size based at least partly on at least one of the calculated negative acknowledgement miss rate and the tolerated negative acknowledgement miss rate.

In some embodiments, the adjustment of the transmit power for the transmission of the negative acknowledgement may include incrementing the transmit power by the first step size when the calculated negative acknowledgement miss rate is above the tolerated negative acknowledgement miss rate.

In some embodiments, the adjustment of the transmit power for the transmission of the negative acknowledgement may include incrementing a transmit power associated with at least one subsequent hybrid automatic repeat request transmission index by the first step size when the calculated negative acknowledgement miss rate for a hybrid automatic repeat request transmission index is above the tolerated negative acknowledgement miss rate.

In some embodiments, the adjustment of the transmit power for the transmission of the negative acknowledgement may include maintaining the incremented transmit power for a second period of time.

In some embodiments, the adjustment of the transmit power for the transmission of the negative acknowledgement may include decrementing the transmit power by the second step size when the calculated negative acknowledgement miss rate is below the tolerated negative acknowledgement miss rate.

In some embodiments, the adjustment of the transmit power for the transmission of the negative acknowledgement may include decrementing a transmit power associated with at least one subsequent hybrid automatic repeat request transmission index by the second step size when the calculated negative acknowledgement miss rate for a hybrid automatic repeat request transmission index is below the tolerated negative acknowledgement miss rate.

In some embodiments, the computer readable medium may further include instructions stored thereon for causing an apparatus to further perform refraining from transmitting the negative acknowledgement when the transmit power for the transmission of the negative acknowledgement is below the second transmit power limit.

In some embodiments, the at least one missed negative acknowledgement may include the negative acknowledgement refrained from being transmitted for which no retransmission has been received on the hybrid automatic repeat request process.

In some embodiments, the adjustment of the transmit power for the transmission of the negative acknowledgement may include refraining from decrementing the transmit power when a retransmission with a requested hybrid automatic repeat request transmission index is received on the hybrid automatic repeat request process.

In some embodiments, the computer readable medium may further include instructions stored thereon for causing an apparatus to further perform transmitting a request for increasing the first transmit power limit based at least on the transmit power and the first transmit power limit, wherein a difference between the transmit power and the first transmit power limit may be below a threshold.

In an eighth aspect, a computer readable medium is disclosed. The computer readable medium may include instructions stored thereon for causing an apparatus as a network device to perform configuring at least one parameter relating to a transmit power for transmission of a negative acknowledgement from at least one terminal device to the network device on a hybrid automatic repeat request process, wherein the negative acknowledgement may indicate a request for a retransmission of a packet sent from the network device to the at least one terminal device, and transmitting the configuration to the at least one terminal device.

In some embodiments, the at least one parameter may be associated with at least one hybrid automatic repeat request transmission index of the hybrid automatic repeat request process, and the at least one parameter may include at least one of a tolerated negative acknowledgement miss rate, a first step size, a second step size, a first transmit power limit, and a second transmit power limit.

In some embodiments, the configuring the at least one parameter relating to the transmit power for the transmission of the negative acknowledgement may include reducing the first transmit power limit when a request for increasing the first transmit power limit from the at least one terminal device is absent.

In some embodiments, the configuring the at least one parameter relating to the transmit power for the transmission of the negative acknowledgement may include increasing the first transmit power limit when receiving from at least one of the at least one terminal device a request for increasing the first transmit power limit.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary sequence diagram for power control on NACK transmission according to an embodiment of the present disclosure.

FIG. 2 shows an overall distribution of a power received at a BS in a simulated scenario in which multiple UE devices use a manually tuned fixed NACK-only transmit power to achieve a tolerated NACK miss rate.

FIG. 3 shows an overall distribution of a power received at a BS in a simulated scenario in which a power control according to an embodiment of the present disclosure is implemented to achieve a tolerated NACK miss rate.

FIG. 4 shows a flow chart illustrating an example method for power control on NACK transmission according to an embodiment of the present disclosure.

FIG. 5 shows a flow chart illustrating an example method for power control on NACK transmission according to an embodiment of the present disclosure.

FIG. 6 shows a block diagram illustrating an example apparatus for power control on NACK transmission according to an embodiment of the present disclosure.

FIG. 7 shows a block diagram illustrating an example apparatus for power control on NACK transmission according to an embodiment of the present disclosure.

FIG. 8 shows a block diagram illustrating an example apparatus for power control on NACK transmission according to an embodiment of the present disclosure.

FIG. 9 shows a block diagram illustrating an example apparatus for power control on NACK transmission according to an embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

A high reliability of the NACK-only feedback may be ensured while the interference in the cell and to the neighboring cells may be kept to an unavoidable minimum through power control on NACK transmission according to embodiments of the present disclosure.

A HARQ process for a transport block (TB) may be identified by a unique HARQ process identifier. On the HARQ process, a HARQ transmission index is an identifier of a HARQ transmission, i.e., a HARQ transmission index may be ‘0’ for a first transmission of the TB, ‘1’ for a first retransmission of the TB, ‘2’ for a second retransmission of the TB, etc.

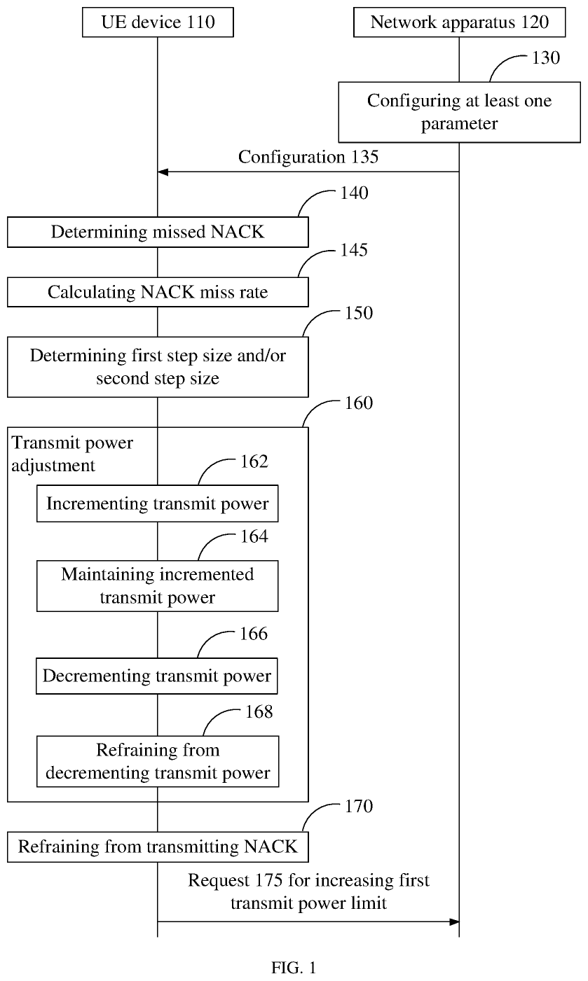

FIG. 1 shows an exemplary sequence diagram for power control on NACK transmission according to an embodiment of the present disclosure. Referring to the FIG. 1, a UE device 110 may be a terminal device to transmit the NACK-only HARQ feedback message on the group-common PUCCH resource, and a network apparatus 120 may be a network device, e.g., in a base station (BS), to perform the HARQ transmission. The UE device 110 is associated with a cell the network apparatus 120 covers.

In an operation 130, the network apparatus 120 may configure at least one parameter relating to a transmit power for transmission of a NACK from at least one terminal device on a HARQ process. The at least one terminal device may be at least one UE device, and the UE device 110 may be any one UE device of the at least one UE device. The NACK may indicate a request for a retransmission of a packet sent to the at least one UE device.

In an embodiment, the at least one parameter may include at least one of a tolerated NACK miss rate, a first step size, a second step size, a first transmit power limit, and a second transmit power limit. The tolerated NACK miss rate may relate to a miss rate target of NACK feedback detection at the BS, e.g., 1%, which means that one percent of the NACKs transmitted by the UE device is not detected at the BS. The first step size may be an incremented amount of the transmit power for the transmission of the NACK, the second step size may be a decremented amount of the transmit power for the transmission of the NACK, the first transmit power limit may be an upper limit of the transmit power for the transmission of the NACK, e.g., 23 dBm, and the second transmit power limit may be a lower limit of the transmit power for the transmission of the NACK.

The at least one parameter may be associated with at least one HARQ transmission index of the HARQ process. For example, the at least one parameter may be configured per HARQ transmission index. Alternatively, the at least one parameter may be configured for a plurality of HARQ transmission indexes. Then, the network apparatus 120 may transmit the configuration 135 to the at least one UE device.

Alternatively or additionally, some of the at least one parameter may be determined by the at least one UE device. For example, the UE device 110 may derive the tolerated NACK miss rate from the packet miss rate target of the PTM service being delivered. For example, if the miss rate target for the PTM service is, e.g., 1%, the tolerated NACK miss rate may be a rate lower than the miss rate target, e.g., 0.5%. The first step size and the second step size may also be determined by the UE device 110, which will be described later.

In an embodiment, the configuration 135 may further include an initial transmit power which may be used by the at least one UE device. Alternatively, the configuration 135 may not include the initial transmit power. For example, the UE device 110 may determine the initial transmit power based on the power used on UE-specific PUCCH or physical uplink shared channel (PUSCH) transmissions and a power offset value initialized based on a signaling from the network apparatus 120. The initial transmit power may be configured or determined per HARQ transmission index or for a plurality of HARQ transmission indexes.

In an operation 140, the UE device 110 may determine at least one missed NACK. The at least one missed NACK may include at least one sent NACK for which no corresponding retransmission from the network apparatus 120 has been received at the UE device 110 on the HARQ process. In an embodiment, the at least one missed NACK may be associated with the at least one HARQ transmission index. For example, the UE device 110 may determine the at least one missed NACK per HARQ transmission index. Alternatively, the UE device 110 may determine the at least one missed NACK for a plurality of HARQ transmission indexes.

In an embodiment, the at least one missed NACK may include at least one sent NACK for which a transmission with a HARQ transmission index is received on the HARQ process, and the HARQ transmission index is different from a HARQ transmission index requested by the UE device 110 for the requested retransmission. For example, when the UE device 110 sent to the network apparatus 120 a NACK to request a retransmission with an HARQ transmission index, and then detects a transmission with a HARQ transmission index different from the requested HARQ transmission index, in this case a new data transmission is detected, and thus the UE device 110 may determine the sent NACK has been missed.

Additionally, in an embodiment, the at least one missed NACK may include at least one sent NACK for which a retransmission with a requested HARQ transmission index requested by the UE device 110 is not detected during a first period of time on the HARQ process. For example, when the UE device 110 sent to the network apparatus 120 a NACK to request a retransmission with an HARQ transmission index, the UE device 110 may start a timer when transmitting the NACK, and if the UE device 110 has not detected the requested retransmission with the requested HARQ transmission index when the timer expires, the UE device 110 may determine the sent NACK has been missed. In an embodiment the timer may be a parameter in the configuration 135.

Additionally, in an embodiment, when the UE device 110 does not transmit a NACK due to the transmit power for the transmission of the NACK being below the second transmit power limit, and no retransmission has been received on the HARQ process, the at least one missed NACK may include the un-transmitted NACK.

In an operation 145, the UE device 110 may calculate a NACK miss rate based at least on the determination of the at least one missed NACK. In an embodiment, the NACK miss rate may be calculated based at least on at least one of a number of the at least one missed NACK and a number of at least one sent NACK. For example, the UE device 110 may count the number of the at least one sent NACK over a certain time window and count the number of the at least one missed NACK over the certain time window. Alternatively, the UE device 110 may count the number of the at least one missed NACK when the number of at least one sent NACK reaches a certain number. Then, the UE device 110 may calculate the NACK miss rate based on the number of the at least one missed NACK and the number of the at least one sent NACK. When the UE device 110 calculates the NACK miss rate based on one sent NACK, the NACK miss rate will be 100% if the one sent NACK is missed, and the NACK miss rate will be zero if a retransmission requested by the one sent NACK is detected. The certain time window and/or the certain number may, e.g., be configured by the network apparatus 120 and be included in the configuration 135.

In an embodiment, the NACK miss rate may be associated with the at least one HARQ transmission index. The NACK miss rate may be calculated per HARQ transmission index. For example, the at least one sent NACK for calculating the NACK miss rate may be associated with one HARQ transmission index. Alternatively, the NACK miss rate may be calculated for a plurality of HARQ transmission indexes. For example, the at least one sent NACK for calculating the NACK miss rate may be associated with a plurality of HARQ transmission indexes.

In an operation 150, the UE device 110 may determine the first step size and/or the second step size based at least partly on at least one of the calculated NACK miss rate and the tolerated NACK miss rate. The first step size and/or the second step size, determined by the UE device 110 or configured by the network apparatus 120, may be a fixed amount. For example, the first step size may be denoted by, e.g., delta_NACK_missed, the second step size may be denoted by, e.g., delta_NACK_honored, and the delta_NACK_honored may, e.g., equal to delta_NACK_missed*rate_NACK_tolerated, which may denote the tolerated NACK miss rate. Alternatively, the UE device 110 may determine the first step size and/or the second step size based on, e.g., a deviation of the calculated NACK miss rate from the tolerated NACK miss rate. For example, the first step size and/or the second step size may be determined in proportion to a difference between the calculated NACK miss rate and the tolerated NACK miss rate. If the difference is small, the first step size and/or the second step size may be determined as a small amount, and if the difference is large, the first step size and/or the second step size may be determined as a large amount.

In an operation 160, the UE device 110 may adjust the transmit power for the transmission of the NACK based at least on the calculated NACK miss rate and the at least one parameter. In an embodiment, the transmit power for the transmission of the NACK may be associated with the at least one HARQ transmission index. The transmit power may be adjusted per HARQ transmission index. For example, the transmit power may be adjusted independently for each HARQ transmission index. Alternatively for example, the transmit power may be adjusted also for at least one subsequent HARQ transmission index.

The operation 160 may include an operation 162, in which the UE device 110 may increment the transmit power. In an embodiment, the UE device 110 may increment the transmit power by the first step size when the calculated NACK miss rate is above the tolerated NACK miss rate. The calculated NACK miss rate may be associated with one HARQ transmission index or a plurality of HARQ transmission indexes. Optionally, the UE device 110 may increment the transmit power by the first step size if a difference between the transmit power and the first transmit power limit is equal to or larger than the first step size, so that the incremented transmit power will not exceed the first transmit power limit. Alternatively, the UE device 110 may adjust the transmit power to or below the first transmit power limit by at least one step with size smaller than the first step size when the transmit power has been incremented above the first transmit power limit.

In an embodiment, when the calculated NACK miss rate for a HARQ transmission index is above the tolerated NACK miss rate, the UE device 110 may increment a transmit power associated with at least one subsequent HARQ transmission index by the first step size. For example, if for a HARQ transmission index n the calculated NACK miss rate is too high, the transmit power may be incremented for the HARQ transmission index n and also for the at least one HARQ transmission index subsequent to the HARQ transmission index n, i.e., n+1 etc. This may ensure that the power control for higher HARQ transmission indexes would not be too slow when there are few NACK transmissions for these higher HARQ transmission indexes.

Optionally, the UE device 110 may increment the transmit power by the first step size if a difference between the transmit power associated with the at least one subsequent HARQ transmission index and the first transmit power limit is equal to or larger than the first step size, so that the incremented transmit power will not exceed the first transmit power limit. Alternatively, the UE device 110 may adjust the transmit power to or below the first transmit power limit by at least one step with size smaller than the first step size when the transmit power has been incremented above the first transmit power limit.

By comparing the calculated NACK miss rate with the tolerated NACK miss rate to determine whether to increment the transmit power, unnecessary increases in the transmit power may be avoided and hence the interference may be inhibited, while an overall NACK miss rate may actually be acceptable.

The operation 160 may include an operation 164, in which the UE device 110 may maintain the incremented transmit power for a second period of time. For example, during the second period of time after the transmit power is incremented, the UE device 110 does not decrement the transmit power with requested and received retransmission, such that a risk of, e.g., another NACK being missed during the second period of time may be avoided.

The operation 160 may include an operation 166, in which the UE device 110 may decrement the transmit power. In an embodiment, the UE device 110 may decrement the transmit power by the second step size when the calculated NACK miss rate is below the tolerated NACK miss rate. The calculated NACK miss rate may be associated with one HARQ transmission index or a plurality of HARQ transmission indexes. Optionally, the UE device 110 may decrement the transmit power by the second step size if a difference between the transmit power and the second transmit power limit is equal to or larger than the second step size, so that the decremented transmit power will not fall below the second transmit power limit. Alternatively, the UE device 110 may adjust the transmit power to or above the second transmit power limit by at least one step with size smaller than the second step size when the transmit power has been decremented below the second transmit power limit.

In an embodiment, when the calculated NACK miss rate for a HARQ transmission index is below the tolerated NACK miss rate, the UE device 110 may decrement a transmit power associated with at least one subsequent HARQ transmission index by the second step size. For example, if for a HARQ transmission index n the calculated NACK miss rate is below the tolerated NACK miss rate, the transmit power may be decremented for the HARQ transmission index n and also for the at least one HARQ transmission index subsequent to the HARQ transmission index n, i.e., n+1 etc. This may ensure that the interference may be inhibited. Optionally, the UE device 110 may decrement the transmit power by the second step size if a difference between the transmit power associated with the at least one subsequent hybrid automatic repeat request transmission index and the second transmit power limit is equal to or larger than the second step size, so that the decremented transmit power will not fall below the second transmit power limit. Alternatively, the UE device 110 may adjust the transmit power to or above the second transmit power limit by at least one step with size smaller than the second step size when the transmit power has been decremented below the second transmit power limit.

The operation 160 may include an operation 168, in which the UE device 110 may refrain from decrementing the transmit power when a retransmission with a requested HARQ transmission index is received on the HARQ process. For example, when the UE device 110 does not transmit a NACK due to the transmit power for the transmission of the NACK being below the second transmit power limit but detects a retransmission that would have been requested, for example, the retransmission may be triggered by a NACK transmitted by another UE device. In this case, the UE device 110 may refrain from decrementing the transmit power.

Alternatively, the UE device 110 may set a lower boundary for the transmit power, and the lower boundary may not be too far from the second transmit power limit. For example, the lower boundary may be above the second transmit power limit minus the first step size denoted by, e.g., delta_NACK_missed, so that the UE device 110 may resume NACK transmissions after incrementing the transmit power by the first step size once.

In an operation 170, the UE device 110 may refrain from transmitting the NACK, when the transmit power for the transmission of the NACK is below the second transmit power limit.

In this case the at least one missed NACK may include the NACK refrained from being transmitted for which no retransmission may be received on the HARQ process. Thus, the NACK miss rate may be increased and the transmit power may be incremented, so the UE device 110 may resume the NACK transmission when the transmit power is above the second transmit power limit.

The UE device 110 may transmit a request 175 for increasing the first transmit power limit based at least on the transmit power and the first transmit power limit. For example, if a difference between the transmit power and the first transmit power limit is below a threshold, the UE device 110 may transmit to the network apparatus 120 the request 175 for increasing the first transmit power limit. On the network side, the network apparatus 120 may in the operation 130 increase the first transmit power limit when receiving from at least one of the at least one UE device a request 175 for increasing the first transmit power limit. Alternatively, when receiving the request 175 from the UE device 110, the network apparatus 120 may configure the UE device 110 via a signaling to use a UE-specific PUCCH resource for transmitting ACK/NACK HARQ feedback instead of transmitting NACK-only HARQ feedback on the group-common PUCCH resource. Thus, the interference caused by the transmit power of the UE device 110 may be inhibited. The network apparatus 120 may perform the configuration per HARQ transmission index and may switch the UE device 110 back to the NACK-only HARQ feedback, e.g., if channel conditions of the UE device 110 have improved. The signaling form the network apparatus 120 to the UE device 110 may be UE-specific, e.g., a UE-specific radio resource control (RRC) signaling or a medium access control-control element (MAC-CE).

The network apparatus 120 may reduce the first transmit power limit when the request 175 for increasing the first transmit power limit from the at least one terminal device is absent. For example, if no UE devices request increments to the first transmit power limit, the network apparatus 120 may gradually lower the first transmit power limit, such that the interference may be inhibited.

The power control on NACK transmission according to embodiments of the present disclosure is a closed-loop and highly dynamic power control autonomously performed by the at least one UE device such as the UE device 110. Each UE device may continuously and autonomously, e.g., without constantly receiving additional NACK-only specific transmit power control (TPC) commands from the network such as the network apparatus 120, control the NACK-only PUCCH transmit power to maintain the tolerated NACK miss rate, thereby not creating more interference than necessary, not consuming more battery power than necessary, minimizing signaling overhead and incurring only nearly trivial UE complexity.

A simulation according to embodiments of the present disclosure is implemented. In the simulation, it is simply assumed that 10 UE devices receive PTM and transmit NACK-only feedback on the same uplink resource, a maximum of 8 HARQ transmissions are used per TB, and each UE device has a 50% chance of decoding the TB after each of the HARQ transmissions.

Transmission of NACKs is simulated over a 1×2 Rayleigh fading channel with Doppler spread normalized by the HARQ round trip time (RTT) of 0.01 seconds. Pathloss is not simulated and the transmit powers are relative and hence have no absolute meaning. The NACK detection is based on a fixed threshold arbitrarily set at −1 dB, and the tolerated NACK miss rate is set to 1%.

The simulation shows that with every HARQ retransmission the number of UE devices transmitting NACK decreases and the transmit power generally increases, and during the adjustment of the transmit power an aggregate received power at a BS typically lies above the NACK detection threshold, such that the tolerated NACK miss rate may be achieved.

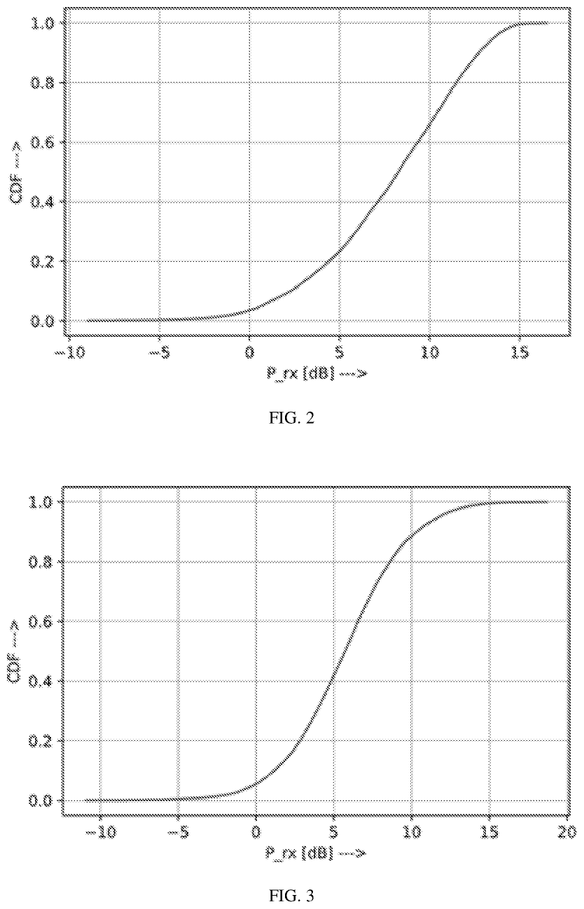

FIG. 2 shows an overall distribution of a power received at the BS in the above simulated scenario in which the multiple UE devices use a manually tuned fixed NACK-only transmit power to achieve the tolerated NACK miss rate. Referring to the FIG. 2, an abscissa axis refers to the power received at the BS denoted by P_rx in units of dB, and a vertical axis refers to a cumulative distribution function (CDF). The FIG. 2 shows that a probability of the received power above 10 dB is around 35%.

FIG. 3 shows an overall distribution of a power received at a BS in the above simulated scenario in which a power control according to an embodiment of the present disclosure is implemented to achieve the tolerated NACK miss rate. Referring to the FIG. 3, an abscissa axis refers to the power received at the BS denoted by P_rx in units of dB, and a vertical axis refers to a CDF. The FIG. 3 shows that the probability of the received power above 10 dB is reduced to around 10%, and the received power is above the NACK detection threshold with probability of around 98% and is hardly ever more than around 15 dB higher than necessary. In realistic scenarios with pathloss, gains may be more considerable.

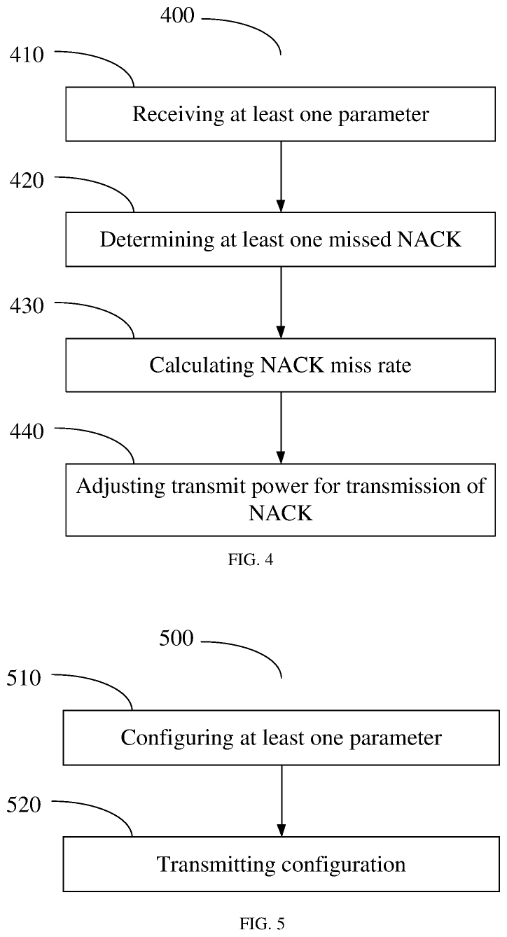

FIG. 4 shows a flow chart illustrating an example method 400 for power control on NACK transmission according to an embodiment of the present disclosure. The example method 400 may be performed for example at a terminal device such as the UE device 110.

Referring to the FIG. 4, the example method 400 may include an operation 410 of receiving at a terminal device from a network device, at least one parameter relating to a transmit power for transmission of a negative acknowledgement from the terminal device to the network device on a hybrid automatic repeat request process, wherein the negative acknowledgement may indicate a request for a retransmission of a packet sent from the network device to the terminal device on a hybrid automatic repeat request process, an operation 420 of determining at least one missed negative acknowledgement, wherein the at least one missed negative acknowledgement may comprise at least one sent negative acknowledgement for which no corresponding retransmission from the network device has been received at the terminal device on the hybrid automatic repeat request process, an operation 430 of calculating a negative acknowledgement miss rate based at least on the determination of the at least one missed negative acknowledgement, and an operation 440 of adjusting the transmit power for the transmission of the negative acknowledgement based at least on the calculated negative acknowledgement miss rate and the at least one parameter.

Details of the operation 410 have been described in the above descriptions with respect to at least the configuration 135, and repetitive descriptions thereof are omitted here.

Details of the operation 420 have been described in the above descriptions with respect to at least the operation 140, and repetitive descriptions thereof are omitted here.

Details of the operation 430 have been described in the above descriptions with respect to at least the operation 145, and repetitive descriptions thereof are omitted here.

Details of the operation 440 have been described in the above descriptions with respect to at least the operation 160, and repetitive descriptions thereof are omitted here.

In an embodiment, the at least one parameter, the at least one missed negative acknowledgement, the negative acknowledgement miss rate and the transmit power for the transmission of the negative acknowledgement are determined per at least one hybrid automatic repeat request transmission index of the hybrid automatic repeat request process. The more details have been described in the above descriptions with respect to at least the configuration 135, the operation 140, the operation 145, and the operation 160, and repetitive descriptions thereof are omitted here.

In an embodiment, the at least one missed negative acknowledgement may comprise at least one sent negative acknowledgement for which a transmission with a hybrid automatic repeat request transmission index is received on the hybrid automatic repeat request process, and the hybrid automatic repeat request transmission index is different from a hybrid automatic repeat request transmission index requested by the terminal device for the requested retransmission. The more details have been described in the above descriptions with respect to at least the operation 140, and repetitive descriptions thereof are omitted here.

In an embodiment, the at least one missed negative acknowledgement may comprise at least one sent negative acknowledgement for which a requested retransmission with a hybrid automatic repeat request transmission index requested by the terminal device is not detected during a first period of time on the hybrid automatic repeat request process. The more details have been described in the above descriptions with respect to at least the operation 140, and repetitive descriptions thereof are omitted here.

In an embodiment, the at least one parameter may comprise at least one of a tolerated negative acknowledgement miss rate, a first step size, a second step size, a first transmit power limit, and a second transmit power limit. The more details have been described in the above descriptions with respect to at least the configuration 135, and repetitive descriptions thereof are omitted here.

In an embodiment, the negative acknowledgement miss rate may be calculated based at least on at least one of a number of the at least one missed negative acknowledgement and a number of at least one sent negative acknowledgement. The more details have been described in the above descriptions with respect to at least the operation 145, and repetitive descriptions thereof are omitted here.

In an embodiment, the example method 400 may further include an operation of determining the first step size and/or the second step size based at least partly on at least one of the calculated negative acknowledgement miss rate and the tolerated negative acknowledgement miss rate. The more details have been described in the above descriptions with respect to at least the operation 150, and repetitive descriptions thereof are omitted here.

In an embodiment, the adjustment of the transmit power for the transmission of the negative acknowledgement may comprise incrementing the transmit power by the first step size when the calculated negative acknowledgement miss rate is above the tolerated negative acknowledgement miss rate. The more details have been described in the above descriptions with respect to at least the operation 162, and repetitive descriptions thereof are omitted here.

In an embodiment, the adjustment of the transmit power for the transmission of the negative acknowledgement may comprise incrementing a transmit power associated with at least one subsequent hybrid automatic repeat request transmission index by the first step size when the calculated negative acknowledgement miss rate for a hybrid automatic repeat request transmission index is above the tolerated negative acknowledgement miss rate. The more details have been described in the above descriptions with respect to at least the operation 162, and repetitive descriptions thereof are omitted here.

In an embodiment, the adjustment of the transmit power for the transmission of the negative acknowledgement may comprise maintaining the incremented transmit power for a second period of time. The more details have been described in the above descriptions with respect to at least the operation 164, and repetitive descriptions thereof are omitted here.

In an embodiment, the adjustment of the transmit power for the transmission of the negative acknowledgement may comprise decrementing the transmit power by the second step size when the calculated negative acknowledgement miss rate is below the tolerated negative acknowledgement miss rate. The more details have been described in the above descriptions with respect to at least the operation 166, and repetitive descriptions thereof are omitted here.

In an embodiment, the adjustment of the transmit power for the transmission of the negative acknowledgement may comprise decrementing a transmit power associated with at least one subsequent hybrid automatic repeat request transmission index by the second step size when the calculated negative acknowledgement miss rate for a hybrid automatic repeat request transmission index is below the tolerated negative acknowledgement miss rate. The more details have been described in the above descriptions with respect to at least the operation 166, and repetitive descriptions thereof are omitted here.

In an embodiment, the example method 400 may further include an operation of refraining from transmitting the negative acknowledgement when the transmit power for the transmission of the negative acknowledgement is below the second transmit power limit. The more details have been described in the above descriptions with respect to at least the operation 170, and repetitive descriptions thereof are omitted here.

In an embodiment, the at least one missed negative acknowledgement may comprise the negative acknowledgement refrained from being transmitted for which no retransmission has been received on the hybrid automatic repeat request process. The more details have been described in the above descriptions with respect to at least the operation 140 and the operation 170, and repetitive descriptions thereof are omitted here.

In an embodiment, the adjustment of the transmit power for the transmission of the negative acknowledgement may comprise refraining from decrementing the transmit power when a retransmission with a requested hybrid automatic repeat request transmission index is received on the hybrid automatic repeat request process. The more details have been described in the above descriptions with respect to at least the operation 168, and repetitive descriptions thereof are omitted here.

In an embodiment, the example method 400 may further include an operation of transmitting a request for increasing the first transmit power limit based at least on the transmit power and the first transmit power limit, wherein a difference between the transmit power and the first transmit power limit is below a threshold. The more details have been described in the above descriptions with respect to at least the request 175, and repetitive descriptions thereof are omitted here.

FIG. 5 shows a flow chart illustrating an example method 500 for power control on NACK transmission according to an embodiment of the present disclosure. The example method 500 may be performed for example at a network device such as the network apparatus 120.

Referring to the FIG. 5, the example method 500 may include an operation 510 of configuring at least one parameter relating to a transmit power for the transmission of a negative acknowledgement from at least one terminal device on a hybrid automatic repeat request process, wherein the negative acknowledgement may indicate a request for a retransmission of a packet sent to the at least one terminal device, and an operation 520 of transmitting the configuration to the at least one terminal device.

Details of the operation 510 have been described in the above descriptions with respect to at least the operation 130 and the configuration 135, and repetitive descriptions thereof are omitted here.

Details of the operation 520 have been described in the above descriptions with respect to at least the configuration 135, and repetitive descriptions thereof are omitted here.

In an embodiment, the at least one parameter may be associated with at least one hybrid automatic repeat request transmission index of the hybrid automatic repeat request process, and the at least one parameter may comprise at least one of a tolerated negative acknowledgement miss rate, a first step size, a second step size, a first transmit power limit, and a second transmit power limit. The more details have been described in the above descriptions with respect to at least the configuration 135, and repetitive descriptions thereof are omitted here.

In an embodiment, the configuring the at least one parameter relating to the transmit power for the transmission of the negative acknowledgement may comprise reducing the first transmit power limit when a request for increasing the first transmit power limit from the at least one terminal device is absent. The more details have been described in the above descriptions with respect to at least the operation 130 and the request 175, and repetitive descriptions thereof are omitted here.

In an embodiment, the configuring the at least one parameter relating to the transmit power for the transmission of the negative acknowledgement may comprise increasing the first transmit power limit when receiving from at least one of the at least one terminal device a request for increasing the first transmit power limit. The more details have been described in the above descriptions with respect to at least the operation 130 and the request 175, and repetitive descriptions thereof are omitted here.

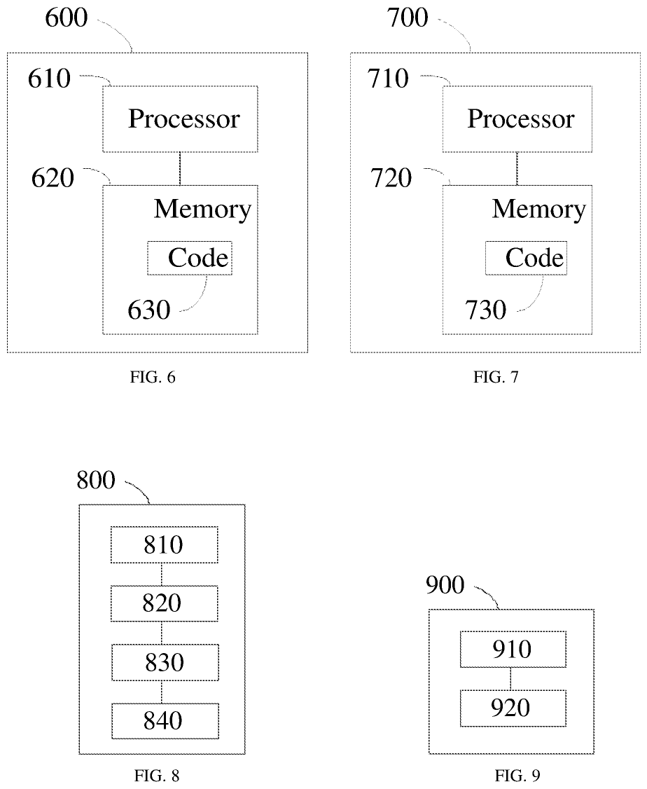

FIG. 6 shows a block diagram illustrating an example apparatus 600 for power control on NACK transmission according to an embodiment of the present disclosure. The apparatus, for example, may be at least part of the UE device 110 in the above examples.

As shown in the FIG. 4, the example apparatus 600 may include at least one processor 610 and at least one memory 620 that may include computer program code 630. The at least one memory 620 and the computer program code 630 may be configured to, with the at least one processor 610, cause the apparatus 600 at least to perform the example method 400 described above.

In various example embodiments, the at least one processor 610 in the example apparatus 600 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 610 may also include at least one other circuitry or element not shown in the FIG. 6.

In various example embodiments, the at least one memory 620 in the example apparatus 600 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 620 may include, but are not limited to, an electric, a magnetic, an optical, an electromagnetic, an infrared, or a semiconductor system, apparatus, or device or any combination of the above.

Further, in various example embodiments, the example apparatus 600 may also include at least one other circuitry, element, and interface, for example at least one I/O interface, at least one antenna element, and the like.

In various example embodiments, the circuitries, parts, elements, and interfaces in the example apparatus 600, including the at least one processor 610 and the at least one memory 620, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus on the side of the UE device 110 is not limited to the above example apparatus 600.

FIG. 7 shows a block diagram illustrating an example apparatus 700 for power control on NACK transmission according to an embodiment of the present disclosure. The apparatus, for example, may be at least part of the network apparatus 120 in the above examples.

As shown in the FIG. 7, the example apparatus 700 may include at least one processor 710 and at least one memory 720 that may include computer program code 730. The at least one memory 720 and the computer program code 730 may be configured to, with the at least one processor 710, cause the apparatus 700 at least to perform at least one of the example method 500 described above.

In various example embodiments, the at least one processor 710 in the example apparatus 700 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 510 may also include at least one other circuitry or element not shown in the FIG. 7.

In various example embodiments, the at least one memory 720 in the example apparatus 700 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 720 may include, but are not limited to, an electric, a magnetic, an optical, an electromagnetic, an infrared, or a semiconductor system, apparatus, or device or any combination of the above.

Further, in various example embodiments, the example apparatus 700 may also include at least one other circuitry, element, and interface, for example at least one I/O interface, at least one antenna element, and the like.

In various example embodiments, the circuitries, parts, elements, and interfaces in the example apparatus 700, including the at least one processor 710 and the at least one memory 720, may be coupled together via any suitable connections including, but not limited to, buses, crossbars, wiring and/or wireless lines, in any suitable ways, for example electrically, magnetically, optically, electromagnetically, and the like.

It is appreciated that the structure of the apparatus on the side of the network apparatus 120 is not limited to the above example apparatus 700.

FIG. 8 shows a block diagram illustrating an example apparatus 800 for power control on NACK transmission according to an embodiment of the present disclosure. The apparatus, for example, may be at least part of the UE device 110 in the above examples.

As shown in FIG. 8, the example apparatus 800 may include means 810 for performing the operation 410 of the example method 400, means 820 for performing the operation 420 of the example method 400, means 830 for performing the operation 430 of the example method 400, and means 840 for performing the operation 440 of the example method 400. In one or more another example embodiments, at least one I/O interface, at least one antenna element, and the like may also be included in the example apparatus 800.

In some example embodiments, examples of means in the example apparatus 800 may include circuitries. For example, an example of means 810 may include a circuitry configured to perform the operation 410 of the example method 400, an example of means 820 may include a circuitry configured to perform the operation 420 of the example method 400, an example of means 830 may include a circuitry configured to perform the operation 430 of the example method 400, and an example of means 840 may include a circuitry configured to perform the operation 440 of the example method 400. In some example embodiments, examples of means may also include software modules and any other suitable function entities.

FIG. 9 shows a block diagram illustrating an example apparatus 900 for power control on NACK transmission according to an embodiment of the present disclosure. The apparatus, for example, may be at least part of the network apparatus 120 in the above examples.

As shown in the FIG. 9, the example apparatus 900 may include means 910 for performing the operation 510 of the example method 500 and means 920 for performing the operation 520 of the example method 500. In one or more other example embodiments, at least one I/O interface, at least one antenna element, and the like may also be included in the example apparatus 900.

In some example embodiments, examples of means in the example apparatus 900 may include circuitries. For example, an example of means 910 may include a circuitry configured to perform the operation 510 of the example method 500, and an example of means 920 may include a circuitry configured to perform the operation 520 of the example method 500. In some example embodiments, examples of means may also include software modules and any other suitable function entities.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
ACK acknowledgement
BS base station
CDF cumulative distribution function
HARQ hybrid automatic repeat request
MAC-CE medium access control-control element
NACK negative acknowledgement
PDSCH physical downlink shared channel
PTM point to multipoint
PUCCH physical uplink control channel
PUSCH physical uplink shared channel
RRC radio resource control
RTT round trip time
TB transport block
TPC transmit power control
UE user equipment

1. A method comprising:
receiving at a terminal device from a network device, at least one parameter relating to a transmit power for transmission of a negative acknowledgement from the terminal device to the network device on a hybrid automatic repeat request process, wherein the negative acknowledgement indicates a request for a retransmission of a packet sent from the network device to the terminal device on the hybrid automatic repeat request process;
determining at least one missed negative acknowledgement, wherein the at least one missed negative acknowledgement comprises at least one sent negative acknowledgement for which no corresponding retransmission from the network device has been received at the terminal device on the hybrid automatic repeat request process;
calculating a negative acknowledgement miss rate based at least on the determination of the at least one missed negative acknowledgement; and
adjusting the transmit power for the transmission of the negative acknowledgement based at least on the calculated negative acknowledgement miss rate and the at least one parameter.

2-20. (canceled)

21. An apparatus comprising:
at least one processor; and
at least one memory comprising computer program code, the at least one memory and the computer program code being configured to, with the at least one processor, cause the apparatus as a terminal device to perform:
receiving from a network device, at least one parameter relating to a transmit power for transmission of a negative acknowledgement from the terminal device to the network device on a hybrid automatic repeat request process, wherein the negative acknowledgement indicates a request for a retransmission of a packet sent from the network device to the terminal device on the hybrid automatic repeat request process;
determining at least one missed negative acknowledgement, wherein the at least one missed negative acknowledgement comprises at least one sent negative acknowledgement for which no corresponding retransmission from the network device has been received at the terminal device on the hybrid automatic repeat request process;
calculating a negative acknowledgement miss rate based at least on the determination of the at least one missed negative acknowledgement; and
adjusting the transmit power for the transmission of the negative acknowledgement based at least on the calculated negative acknowledgement miss rate and the at least one parameter.

22. The apparatus of claim 21, wherein the at least one parameter, the at least one missed negative acknowledgement, the negative acknowledgement miss rate and the transmit power for the transmission of the negative acknowledgement are determined per at least one hybrid automatic repeat request transmission index of the hybrid automatic repeat request process.

23. The apparatus of claim 21, wherein the at least one missed negative acknowledgement comprises at least one sent negative acknowledgement for which a transmission with a hybrid automatic repeat request transmission index is received on the hybrid automatic repeat request process, and the hybrid automatic repeat request transmission index is different from a hybrid automatic repeat request transmission index requested by the terminal device for the requested retransmission.

24. The apparatus of claim 21, wherein the at least one missed negative acknowledgement comprises at least one sent negative acknowledgement for which a requested retransmission with a hybrid automatic repeat request transmission index requested by the terminal device is not detected during a first period of time on the hybrid automatic repeat request process.

25. The apparatus of claim 21, wherein the at least one parameter comprises at least one of a tolerated negative acknowledgement miss rate, a first step size, a second step size, a first transmit power limit, and a second transmit power limit.

26. The apparatus of claim 21, wherein the negative acknowledgement miss rate is calculated based at least on at least one of a number of the at least one missed negative acknowledgement and a number of at least one sent negative acknowledgement.

27. The apparatus of claim 26, wherein the at least one memory and the computer program code are further configured to, with the at least one processor, cause the apparatus to further perform: determining the first step size and/or the second step size based at least partly on at least one of the calculated negative acknowledgement miss rate and the tolerated negative acknowledgement miss rate.

28. The apparatus of claim 26, wherein the adjustment of the transmit power for the transmission of the negative acknowledgement comprises:
incrementing the transmit power by the first step size when the calculated negative acknowledgement miss rate is above the tolerated negative acknowledgement miss rate.

29. The apparatus of claim 26, wherein the adjustment of the transmit power for the transmission of the negative acknowledgement comprises:
incrementing a transmit power associated with at least one subsequent hybrid automatic repeat request transmission index by the first step size when the calculated negative acknowledgement miss rate for a hybrid automatic repeat request transmission index is above the tolerated negative acknowledgement miss rate.

30. The apparatus of claim 28, wherein the adjustment of the transmit power for the transmission of the negative acknowledgement comprises:
maintaining the incremented transmit power for a second period of time.

31. The apparatus of claim 25, wherein the adjustment of the transmit power for the transmission of the negative acknowledgement comprises:
decrementing the transmit power by the second step size when the calculated negative acknowledgement miss rate is below the tolerated negative acknowledgement miss rate.

32. The apparatus of claim 25, wherein the adjustment of the transmit power for the transmission of the negative acknowledgement comprises:
decrementing a transmit power associated with at least one subsequent hybrid automatic repeat request transmission index by the second step size when the calculated negative acknowledgement miss rate for a hybrid automatic repeat request transmission index is below the tolerated negative acknowledgement miss rate.

33. The apparatus of claim 31, wherein the at least one memory and the computer program code are further configured to, with the at least one processor, cause the apparatus to further perform:
refraining from transmitting the negative acknowledgement when the transmit power for the transmission of the negative acknowledgement is below the second transmit power limit.

34. The apparatus of claim 33, wherein the at least one missed negative acknowledgement comprises the negative acknowledgement refrained from being transmitted for which no retransmission has been received on the hybrid automatic repeat request process.

35. The apparatus of claim 33, wherein the adjustment of the transmit power for the transmission of the negative acknowledgement comprises:
refraining from decrementing the transmit power when a retransmission with a requested hybrid automatic repeat request transmission index is received on the hybrid automatic repeat request process.

36. The apparatus of claim 21, wherein the at least one memory and the computer program code are further configured to, with the at least one processor, cause the apparatus to further perform:
transmitting a request for increasing the first transmit power limit based at least on the transmit power and the first transmit power limit, wherein a difference between the transmit power and the first transmit power limit is below a threshold.

37. An apparatus comprising:
at least one processor; and
at least one memory comprising computer program code, the at least one memory and the computer program code being configured to, with the at least one processor, cause the apparatus as a network device to perform:
configuring at least one parameter relating to a transmit power for transmission of a negative acknowledgement from at least one terminal device to the network device on a hybrid automatic repeat request process, wherein the negative acknowledgement indicates a request for a retransmission of a packet sent from the network device to the at least one terminal device; and
transmitting the configuration to the at least one terminal device.

38. The apparatus of claim 37, wherein the at least one parameter, the at least one missed negative acknowledgement, the negative acknowledgement miss rate and the transmit power for the transmission of the negative acknowledgement are determined per at least one hybrid automatic repeat request transmission index of the hybrid automatic repeat request process.

39. The apparatus of claim 38, wherein the configuring the at least one parameter relating to the transmit power for the transmission of the negative acknowledgement comprises:
reducing the first transmit power limit when a request for increasing the first transmit power limit from the at least one terminal device is absent.

40. The apparatus of claim 38, wherein the configuring the at least one parameter relating to the transmit power for the transmission of the negative acknowledgement comprises:
increasing the first transmit power limit when receiving from at least one of the at least one terminal device a request for increasing the first transmit power limit.

41-44. (canceled)
